(19) United States
(12) Patent Application Publication
(10) Pub. No.: US 2017/0026777 A1
(43) Pub. Date: Jan. 26, 2017

(54) BLUETOOTH LOW ENERGY INTERLACED ADVERTISING AND SCANNING

(71) Applicant: QUALCOMM Incorporated, San Diego, CA (US)

(72) Inventors: Huibert DENBOER, Escondido, CA (US); Brian Arnold REDDING, Urbana, IL (US); Joel Benjamin LINSKY, San Diego, CA (US)

(21) Appl. No.: 14/809,256

(22) Filed: Jul. 26, 2015

(51) Int. Cl. H04W 4/00; H04W 72/04; H04W 8/00

(52) U.S. Cl. CPC H04W 4/008; H04W 8/005; H04W 72/0446

(57) ABSTRACT

In an embodiment, a wireless device for Bluetooth Low Energy technology utilizes interlaced advertising and scanning on a same advertising channel to improve power efficiency. In an embodiment, a device transmits an advertising packet on an advertising channel, waits for an inter frame space, listens for any connection request or scan request during a listening time slot, and upon not receiving a connection request or scan request, begins a scanning window on the same advertising channel to listen to advertising packets. If no advertising packets are received, the advertising channel is incremented and the process of interlaced advertising and scanning begins again.

### FIELD OF DISCLOSURE

Embodiments relate to wireless devices, and more particularly to low power wireless devices.

### BACKGROUND

Bluetooth® Low Energy (BLE), marketed as Bluetooth® Smart, is a wireless technology for establishing packet-based wireless networks among wireless devices operating in the 2.4 GHz to 2.4835 GHz frequency range with significantly reduced power consumption compared to legacy Bluetooth devices, sometimes referred to as Classic Bluetooth devices. Bluetooth® is a registered trademark of the Bluetooth Special Interest Group (SIG), incorporated in Delaware, with global headquarters in Kirkland, Wash. (See www.bluetooth.org.) The Bluetooth SIG maintains the specifications for Bluetooth Smart, presently the Bluetooth Specification 4.0 and the Bluetooth Specification 4.1, where version 4.1 provides an update to version 4.0.

Low power wireless devices compliant with the Bluetooth Smart specification are expected to find applications in healthcare, fitness, security, home appliances, and home entertainment, to name a few examples. Such devices are marketed as Bluetooth Smart devices, and are expected to run for long periods of time, perhaps years, on a button or coin battery. Bluetooth Smart Ready devices are wireless devices with dual protocol stacks capable of communicating with legacy Classic Bluetooth devices as well as Bluetooth Smart devices. For example, a cellphone may have Bluetooth Smart Ready capability so that it may communicate with a legacy Classic Bluetooth headset as well as a personal device having Bluetooth Smart capability.

A Bluetooth Smart device may be configured as a central (master) or peripheral (slave). Often the central is a smartphone, tablet, or personal computer. A master may set up a wireless network with multiple peripherals, where connections are established between the master and each peripheral. A Bluetooth Smart device may also be configured as a server or a client. In practice, the server may be thought of as having data of interest, where a client connects with the server to request the data and perhaps modify the state of the server. Usually, the central is the client and a peripheral is the server.

For example, a Bluetooth Smart home thermostat may store temperature values over some period of time, and perform as a server and peripheral to a smartphone when the smartphone is brought in proximity to the home thermostat. The home thermostat may advertise itself so that when the smartphone is in range a connection is established with the smartphone as the central and the home thermostat as the peripheral. In this example, the smartphone performs as the client, requesting the stored temperature values from the home thermostat. Based upon an application running on the smartphone, the smartphone may change the state of the thermostat whereby the home thermostat's temperature setting is raised or lowered depending upon the stored temperature readings and other information that the smartphone may access from the home thermostat or perhaps from cloud-based databases.

Bluetooth Smart technology will find applications in many devices in common use around a home, office, or factory. For example, FIG. 1 illustrates a wireless network in which the smartphone 102 may be a master and client to multiple Bluetooth Smart capable devices: the wristwatch 104 with a sensor to measure pulse rate; the home thermostat 106; the key fob 108 with stored car seat settings and other car preferences; the athletic shoe 110 with a pedometer; the wristband 112 with a sensor to measure blood pressure and heart rate; the personal thermometer 114; the weight scale 116; the laptop 118; and the television 120. The smartphone 102 may be connected to the Internet 122 so that various databases may be accessed to store readings or to adjust the state of some of the Bluetooth Smart devices, or perhaps to alert a health care professional or emergency service personnel if a reading from a Bluetooth Smart device indicates a health issue or urgent situation.

### SUMMARY

Embodiments of the invention are directed to systems and methods for Bluetooth Low Energy interlaced advertising and scanning.

In one embodiment, a method for a communication device to advertise and scan, the method comprising: transmitting by the communication device a first advertising packet on a first advertising channel; listening by the communication device on the first advertising channel for a connection request or scan request during a first listening time slot after waiting for a time interval at the end of the first advertising packet; processing by the communication device a connection request or scan request if received during the first listening time slot; scanning by the communication device on the first advertising channel during a first scanning window for advertising packets upon the end of the first listening time slot if no connection request or scan request is received during the first listening time slot; processing by the communication device an advertising packet if received during the first scanning window; and incrementing by the communication device the first advertising channel to provide a second advertising channel if no advertising packet is received during the first scanning window.

In one embodiment, a communication device comprises: an antenna; a processor coupled to the antenna to implement a communication protocol, the communication protocol comprising; transmitting by the communication device via the antenna a first advertising packet on a first advertising channel; listening by the communication device via the antenna on the first advertising channel for a connection request or scan request during a first listening time slot after waiting for a time interval at the end of the first advertising packet; processing by the communication device a connection request or scan request if received during the first listening time slot; scanning by the communication device via the antenna on the first advertising channel during a first scanning window for advertising packets upon the end of the first listening time slot if no connection request or scan request is received during the first listening time slot; processing by the communication device an advertising packet if received during the first scanning window; and incrementing by the communication device the first advertising channel to provide a second advertising channel if no advertising packet is received during the first scanning window.

In one embodiment, a non-transitory computer readable medium having instructions stored thereon that when executed by a communication device causes the communication device to perform a method comprising: transmitting by the communication device a first advertising packet on a first advertising channel; listening by the communication device on the first advertising channel for a connection request or scan request during a first listening time slot after waiting for a time interval at the end of the first advertising packet; processing by the communication device a connection request or scan request if received during the first listening time slot; scanning by the communication device on the first advertising channel during a first scanning window for advertising packets upon the end of the first listening time slot if no connection request or scan request is received during the first listening time slot; processing by the communication device an advertising packet if received during the first scanning window; and incrementing by the communication device the first advertising channel to provide a second advertising channel if no advertising packet is received during the first scanning window.

In one embodiment, a method for a communication device to advertise and scan, the method comprising: means for transmitting by the communication device a first advertising packet on a first advertising channel; means for listening by the communication device on the first advertising channel for a connection request or scan request during a first listening time slot after waiting for a time interval at the end of the first advertising packet; means for processing by the communication device a connection request or scan request if received during the first listening time slot; means for scanning by the communication device on the first advertising channel during a first scanning window for advertising packets upon the end of the first listening time slot if no connection request or scan request is received during the first listening time slot; means for processing by the communication device an advertising packet if received during the first scanning window; and means for incrementing by the communication device the first advertising channel to provide a second advertising channel if no advertising packet is received during the first scanning window.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates various consumer devices in which embodiments may find applications.

FIG. 2 is a time line illustrating the activity of a communication device according to a conventional Bluetooth Low Energy technology.

FIG. 3 is a time line illustrating the activity of a communication device according to an embodiment.

FIG. 4 is a flow diagram illustrating the activity of a communication device according to an embodiment.

FIG. 5 illustrates the architecture of a communication device in which embodiments may find applications.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that specific circuits (e.g., application specific integrated circuits (ASICs)), one or more processors executing program instructions, or a combination of both, may perform the various actions described herein. Additionally, the sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A Bluetooth Smart device operates among 40 channels in the 2.4 GHz to 2.4835 GHz frequency range, with a channel spacing of 2 MHz. The data rate is 1 Mbps, with Gaussian frequency shift keying (GFSK) modulation for each symbol. The frequency of a channel may be expressed by f(k)=2402+2k(MHz), where k is an RF (Radio Frequency) channel index with values in the range 0, 1, . . . , 39. The RF channel index is mapped into advertising channels and data channels, where the RF channel index values 0, 12, and 39 are mapped into three advertising channel index values 37, 38, and 39, respectively. The remaining RF channel index values are mapped into 37 data channel index values 0, 1, . . . , 36.

To reduce interference among multiple Bluetooth Smart devices, each Bluetooth Smart device may employ carrier frequency hopping once a data connection is established. For example, adaptive frequency hopping may be employed during data connection, where the data channel index k(n+1) at the (n+1)^{th} hop in terms of the data channel index k(n) at the n^{th} hop is given by k(n+1)=(k(n)+Hop_Inc) mod 37, where the integer Hop_Inc is a hop increment.

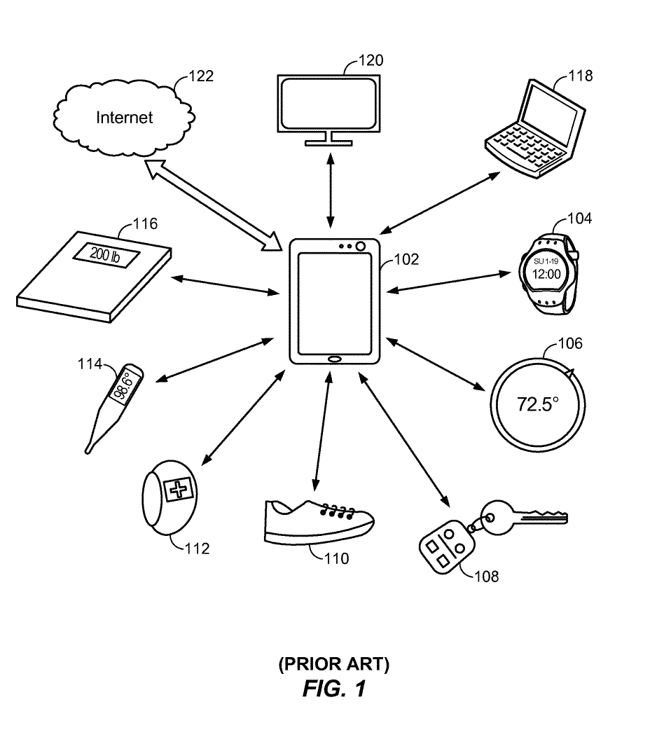

In this description of embodiments, the term “communication device” is used to connote any one of a number of communication devices that may include Bluetooth Smart capability. A communication device may be, for example, a smartphone, tablet, or laptop, or any one of the devices discussed with respect to FIG. 1, to name a few examples. A communication device may therefore, in addition to being Bluetooth Smart capable, be able to communicate in various wireless networks, such as for example a Wi-Fi® network (Wi-Fi is a registered trademark of the Wi-Fi Alliance) or a cellular network (e.g., GSM, UMTS, LTE), to name a few examples. A communication device may be able to communicate with other communication devices, or access servers, via the Internet by way of a wireless network (e.g., a Wi-Fi network or cellular network).

A communication device uses advertising events before a data connection is established. During advertising events, a communication device may be in an advertising state or a scanning state. A communication device in an advertising state is referred to as an advertiser, and a communication device in a scanning state is referred to as a scanner. When a connection is established after one or more advertising events, communication devices use connection events for sending data packets between a central and a peripheral.

An advertiser sends advertising packets in an advertising event. An advertiser begins an advertising event by transmitting an advertising packet on one of the advertising channels. The time duration of an advertising packet varies by payload, and for an embodiment may be in the range of 128 μs to 366 μs. After a wait time referred to as an Inter Frame Space (T_IFS), the advertiser listens for any scanners. For an embodiment, T_IFS may be 150 μs and the listening time may be 50 μs. If another communication device acting as a scanner detects the advertising packet, then depending upon the type of the advertising packet, the scanner may reply with a request packet, whereupon the advertiser replies back with a response packet.

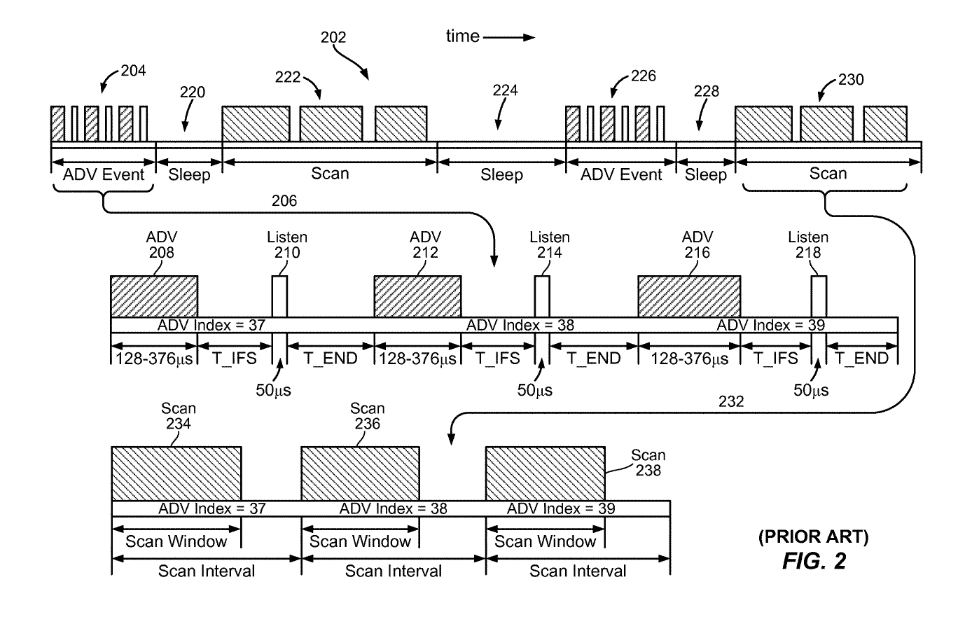

An advertiser may advertise sequentially on some or all of the three advertising channels, and a scanner may listen (scan) sequentially on some or all of the three advertising channels. In conventional Bluetooth Smart technology, a communication device normally performs as an advertiser for a sequence of three advertising packets before performing as a scanner for a sequence of three scanning intervals. This is illustrated in FIG. 2.

FIG. 2 illustrates the activity of a communication device when acting at various times as an advertiser and at other times as a scanner. The time line 202 begins with an advertising event 204. The advertising event 204 includes three advertising packets, shown in more detail in the time line pointed to by the arrow 206 (and referred to as the time line 206). As seen in the time line 206, the advertising event 204 may be viewed as having three sub-events, each sub-event comprising an advertising packet followed by a listening time slot. For example, the first sub-event comprises the advertising packet 208 and the listening time slot 210, with a time interval T_IFS in between. The RF channel index for this first sub-event is 0, which maps to the advertising channel index 37. After a time interval indicated by T_End, which may vary, a second sub-event event begins comprising the advertising packet 212 followed by the listening time slot 214. (The time interval T_END may vary because an embodiment may space the beginning of advertising packets 208 and 212 apart by up to 10 ms. A typical implementation may compress these advertising packets as close together as possible resulting in a very short T_END duration.)

The RF channel index is 12 for the second sub-event comprising the advertising packet 212 and the listening time slot 214, where the RF channel index 12 maps to the advertising channel index 38. Again, after a time interval indicated by T_End, a third sub-event begins with the advertising packet 216 followed by the listening time slot 218. The RF channel index for this third sub-event is 39, which maps to the advertising channel index 39. In the example of FIG. 2, during the advertising event 204 (the time line 206), it is assumed that another communication device, acting as a scanner, is not available (or not detected).

At the end of the third sub-event in the advertising event 204, the communication device enters into a sleep mode as indicated by the sleep interval 220. After the sleep interval 220, the communication device becomes a scanner and a scanning event, labeled 222, begins. In the time line 202, the sleep interval 224 follows the scanning event 222, and the communication device once again becomes an advertiser as indicated by the advertising event 226. For ease of illustration, it is assumed that another communication device acting as a scanner is not available (or not detected) during the advertising event 226, so that after the advertising event 226 has completed the communication device again enters a sleep mode as indicated by the sleep interval 228. After the sleep interval 228, the communication device again becomes a scanner and begins the scanning event 230.

For illustrative purposes the scanning event 230 is shown in more detail by the time line pointed to by the arrow 232 (and referred to as the time line 232). The scanning event in the time line 232 comprises the three scanning windows 234, 236, and 238. In an embodiment, a scanning window is in the range of 775 μs to 3.42 seconds. During these three scanning windows, the scanner listens for an advertising packet. For ease of illustration, it is assumed that another communication device acting as an advertiser is not available (or not detected) during the two scanning events 222 and 230, so that the time line 232 shows three scanning windows without any activity from an advertiser. The RF channel index values during the scanning windows 234, 236, and 238, are respectively 0, 12, and 39. Each scanning window occurs within a scanning interval.

From the time lines illustrated in FIG. 2, it is seen that a communication device enters and exits advertising states, scanning states, and sleep states. For example, during an advertising event, the communication device performs a sequence of transmitting an advertising packet, waiting during the Inter Frame Space, listening during the listening time slot, and waiting again during the time interval indicated as T_END in the time line 206. Such activity results in power consumption because the communication device is often re-tuning its frequency synthesizer, waiting and idling before listening for responses to its advertisements, and switching in and out of the sleep mode.

A communication device according to an embodiment interlaces advertising packets and scanning windows having the same advertising channel index. In an embodiment, for some advertising channel index k, an advertising packet is transmitted at the advertising channel index k followed by a combined listening time slot and scanning window at the same advertising channel index k. Waiting and sleep intervals are not necessarily introduced after every advertising packet and scanning window. Interlacing advertising packets with scanning windows at the same advertising channel index without intervening sleep intervals is expected to be more power efficient than the prior art methods discussed above because less time is expended in re-tuning frequency synthesizers and in entering and exiting sleep states.

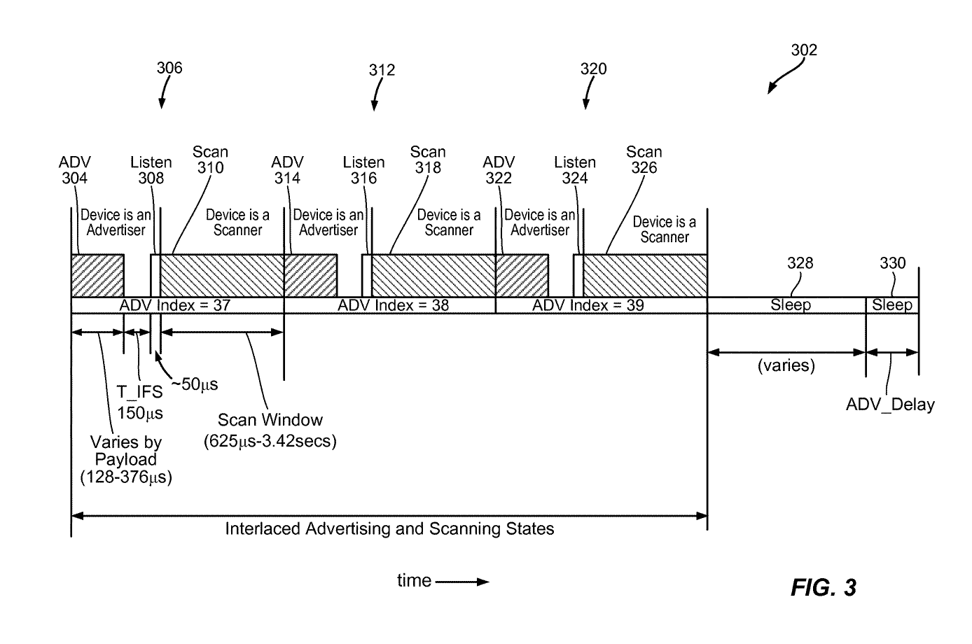

The time line 302 in FIG. 3 illustrates activity of a communication device according to an embodiment. In a communication device according to an embodiment, for each advertising channel index for which an advertising packet takes place, a scanning window follows on the same advertising channel immediately (e.g., a short time) after the end of the listening time slot for the advertising packet, without an intervening sleep interval.

For example, referring to FIG. 3, the beginning of an advertising packet 304 marks the beginning of a combined advertising and scanning sub-event, labeled 306, where the advertising channel index is set to 37. When the advertising packet 304 ends, a listening time slot 308 follows at a time interval T_IFS after the end of the advertising packet 304. At the end of the listening time slot 308, the scanning window 310 begins, without an intervening sleep interval, and on the same channel index 37.

The communication device during the listening time slot 308 is an advertiser, and is listening for another communication device that may respond to the advertising packet 304. In response to transmitting the advertising packet 304, the communication device may receive a connection request or a scan request from another communication device that has received the transmitted advertising packet 304. The controller in the communication device responds to a connection request or a scan request autonomously, and sends a notification to the host layer if a connection was established in response to a connection request. For some embodiments, the host layer may configure the controller to respond only to certain communication devices.

The communication device during the scanning window 310 is a scanner, and is listening for another communication device that may be advertising. For some embodiments, the link layer in the protocol stack of the communication device passes an advertising packet received from another communication device to its host layer. However, as described above with respect to connection and scan requests, the host layer may configure the controller to handle a received advertising packet without waking up the host layer. For example, in response to a received advertising packet, the communication device may transmit a scan request and subsequently receive a scan response in return. The same channel index 37 is used for the advertising and scanning in the combined advertising event and scanning event 306 are performed on.

In the example of FIG. 3, it is assumed that another communication device, whether acting as an advertiser or as a scanner, is not available (or not detected). In such a case, the communication device, if programmed to transmit on a second advertising channel, begins another combined advertising and scanning sub-event, labeled 312, on the advertising channel index 38. The communication device, acting as an advertiser, begins transmitting the advertising packet 314, and after a time interval T_IFS enters the listening time slot 316. At the end of the listening time slot 316, the communication device acts as a scanner during the scanning window 318 on the same channel index 38 and without an intervening sleep interval.

If again another communication device, whether acting as an advertiser or as a scanner, is not available (or not detected), and if the communication device is programmed to transmit on a third advertising channel, the communication device begins another combined advertising and scanning sub-event, labeled 320, on the advertising channel index 39. The communication device, acting as an advertiser, begins transmitting the advertising packet 322, and enters the listening time slot 324 at a time interval T_IFS after the end of the advertising packet 322. At the end of the listening time slot 324, the communication device acts as a scanner during the scanning window 326 on the same channel index 39 and without an intervening sleep interval.

Assuming no other communication device is detected, the communication device enters a sleep mode during the sleep interval 328. An additional time interval, denoted as ADV_delay and labeled as the sleep interval 330 in FIG. 3, may be added to the sleep interval 328. The value of ADV_delay may be obtained from a pseudo-random number generator, so that dithering is added to the timing of the combined advertising and scanning sub-event. After being in a sleep mode during the sleep intervals 328 and 330, the communication device according to an embodiment begins again the procedure illustrated in FIG. 3.

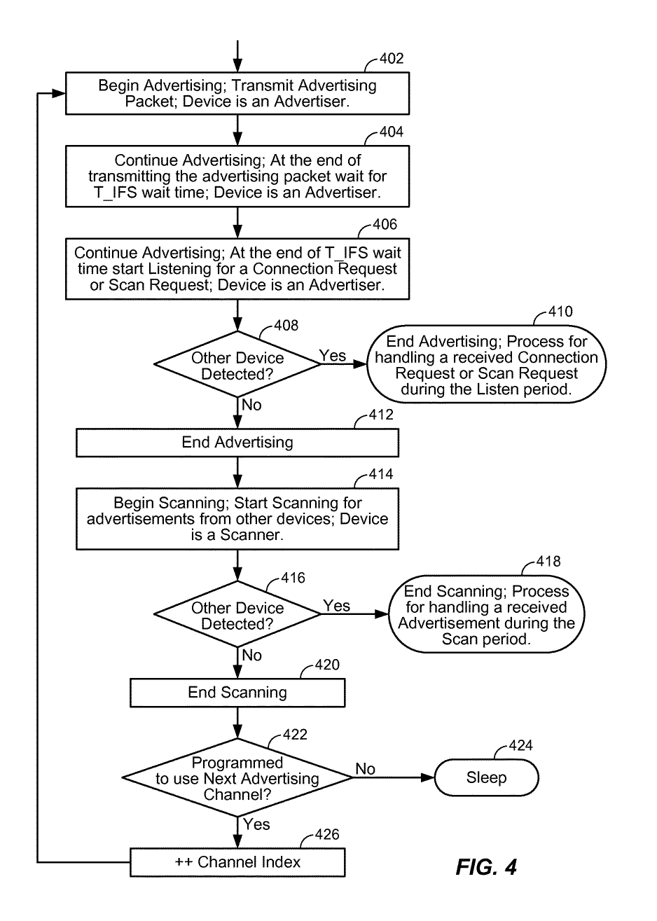

FIG. 4 is a flow diagram illustrating the activity of a communication device according to an embodiment. In step 402, the communication device begins advertising by transmitting an advertising packet. The communication device is an advertiser in the advertising state. In step 404, at the end of the advertising packet, the communication device continues in the advertising state for a time interval T_IFS. After the time interval T_IFS, in step 406 the communication device, still in the advertising state, listens for any connection request or scan request from another advice.

After listening, as indicated in step 408, a determination is made as to whether a connection request or scan request has been received. If such a communication has been received by another communication device, then as indicated in step 410 the advertising is stopped and a standard procedure for handling a received connection request or scan request is performed. That is, a received connection request or scan request may be handled by the controller without necessarily waking up the host layer, and the appropriate procedure is performed, such as a standard procedure as described in the Bluetooth Specification 4.0 and 4.1.

If no connection request or scan request is received, then as indicated in step 412 the communication device ends advertising, and in step 414 the communication device starts scanning for advertisements from other communication devices on the same channel. The communication device is now a scanner in the scanning state.

A determination is made in step 416 as to whether another communication device has been detected. If another communication device has been detected, then in step 418 the communication device ends the scanning, and processes any received advertisement during the scanning window, such as passing a received advertising packet to the host layer to perform a standard procedure as described in the Bluetooth Specification 4.0 and 4.1. If no other communication device has been detected during the scanning window, then in step 420 the communication device ends the scanning. In step 422, a determination is made as to whether the communication device has been programmed to advertise on the next channel. If not, then the communication device enters a sleep mode is indicated in step 424. If the communication device has been programmed to advertise on the next channel, then as indicated in step 426 the channel index is incremented and control is brought back to step 402 so that the above described processes may be repeated for the next advertising channel.

For example, if the advertising channel index was 37, then the next advertising channel index would be 38; or if the advertising channel index was 38, then the next advertising channel index would be 39. Accordingly, in step 426 the advertising channel index is incremented by one and the procedure begins anew in step 402 but with the incremented advertising channel index. If the communication device is programmed not to use a next advertising channel index, or if the last advertising channel index has been used, then the communication device enters into a sleep mode, as indicated in step 424. The process indicated in FIG. 4 may begin again after the sleep interval has expired.

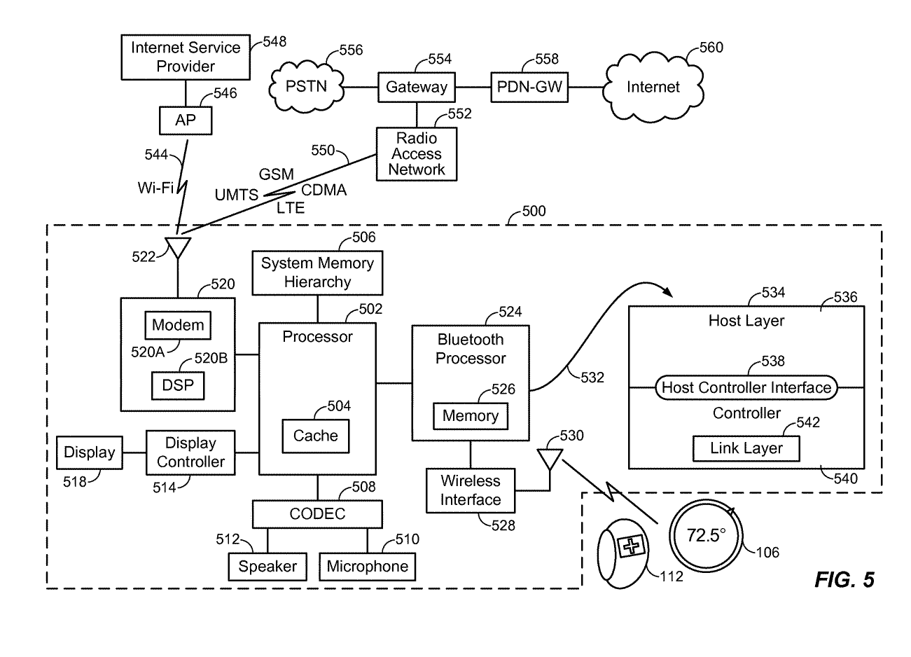

FIG. 5 illustrates a communication device 500 in which embodiments may find application. The communication device 500 may be any one of a number of communication devices, such as a smartphone, tablet, or laptop, to name a few examples. The main processor 502 for the communication device 500 runs applications visible to the user of the communication device 500, and includes the cache memory 504 as well as an interface to store and retrieve data and instructions from off-chip memory, represented in FIG. 5 as the system memory hierarchy 506. The system memory hierarchy 506 may comprise various volatile and non-volatile memory systems. Also shown in FIG. 5 is the CODEC (Coder-Decoder) 508 for interfacing with the microphone 510 and the speaker 512. The display controller 514 provides an interface to the display 518 so that the user may easily interact with the communication device 500.

The communication device 500 is capable of interfacing with other wireless networks by way of the communication functional unit 520 and the antenna 522. The communication functional unit is illustrated as comprising the modem 520A and the digital signal processor (DSP) 520B, although in practice other kinds of modules may be employed, all or some such modules may be integrated on a single chip, and some of the modules may be integrated with the processor 502.

The main processor 502 may implement a Bluetooth Smart or Bluetooth Smart Ready protocol stack in which instructions for performing some or all of the protocol stack are stored in the system memory hierarchy 506. However, in the example of FIG. 5, a separate chip or an embedded hardware core, shown as the Bluetooth processor 524, implements the portions of the protocol stack to perform the steps indicated in FIG. 4. The Bluetooth processor 524 comprises the memory 526, shown as an on-chip memory, although the memory 526 may be part of a memory hierarchy in which some memory also resides off-chip. The wireless interface 528 provides an interface to the antenna 530, suitable for operating in the designated frequency spectrum utilized by Bluetooth. Communication may be made any number of Bluetooth Smart capable devices, such as for example the home thermostat 106 or the wristband 112, to name just two examples.

The arrow 532 serves to indicate that the Bluetooth processor 524 performs the protocol stack, represented by the box labeled 534. Shown in the protocol stack 534 are the host layer 536, the host controller interface 538, and the controller 540. The controller 540 includes the link layer 542. For ease of illustration, not all layers are shown. Software or firmware running on the Bluetooth processor 524 may implement all or some of the layers in the protocol stack 534, and special purpose hardware, such as an ASIC, may also implement some of the layers.

It is to be appreciated that the Bluetooth processor 524 may represent more than one processor, where for example a programmable processor may implement the host layer 536 and a DSP may implement some or all of the actions performed by controller 540, except perhaps for the physical layer (not shown). The instructions for implementing some or all of the actions indicated in FIG. 4 may be stored in a memory, such as for example the memory 526. The memory 526 may be referred to as a non-transitory computer readable medium.

The link layer 542 may implement many of the steps illustrated in FIG. 4, and the host layer 536 may implement the procedures for handling a response to a received advertisement, such as step 418, or the procedures for handling a response to a connection request or a scan request, such as step 410. An embodiment may include a command (not found in the Bluetooth Low Energy specification) by which the host layer 536 instructs the link layer 542 to perform the interlaced advertising and scanning as described by steps 402 through 426. Such a command is in contrast to the standard commands in the Bluetooth Low Energy specification that allow the host layer 536 to instruct the link layer 542 to go into an advertising state or a scan state, but not to perform both advertising and scanning in an interlaced fashion as described herein. The controller 540, such as the physical layer, includes the capability to transition from transmit to receive on the same channel without re-turning a frequency synthesizer.

The communication device 500 can participate in one or more wireless networks to gain access to the Internet. In the example of FIG. 5, the communication device 500 has a Wi-Fi link 544 to the access point (AP) 546, where the Internet service provider (ISP) 548 provides access to the Internet.

The communication device 500 may also have the functionality of a cellular phone so as to participate in any one of a number of cellular networks. For example, the communication device 500 has an air interface link 550 which may for example be compatible network systems according to CDMA (Code Division Multiple Access), GSM (Global System for Mobile Communications), UMTS (Universal Mobile Telecommunications Systems), and LTE (Long-Term Evolution). The air interface link 550 provides communication to a radio access network 552, where the architecture of the radio access network 552 depends upon the type of network standard. For example, in the case of a GSM network, the radio access network 552 includes a base station, where for UMTS it includes a Node-B, and where for LTE it includes eNode-B, as specified by 3GPP (3rd Generation Partnership Project).

Not all functional units are illustrated in FIG. 5 for providing a connection to the Internet, but for ease of illustration several components are shown, such as the Gateway 554 that generically represents several network components for providing communication to the public switched telephone network (PSTN) 556 and the packet data network gateway (PDN-GW) 558, where the PDN-GW 558 provides the proper communication interface to the Internet 560. Clearly, the network architecture illustrated in FIG. 5 for the Wi-Fi link 544 and the air interface link 550 is simplified for ease of illustration.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for Bluetooth Low Energy interlaced advertising and scanning. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for a communication device to advertise and scan, the method comprising:
transmitting by the communication device a first advertising packet on a first advertising channel;
listening by the communication device on the first advertising channel for a connection request or scan request during a first listening time slot after waiting for a time interval at the end of the first advertising packet;
processing by the communication device a connection request or scan request if received during the first listening time slot;
scanning by the communication device on the first advertising channel during a first scanning window for advertising packets upon the end of the first listening time slot if no connection request or scan request is received during the first listening time slot;
processing by the communication device an advertising packet if received during the first scanning window; and
incrementing by the communication device the first advertising channel to provide a second advertising channel if no advertising packet is received during the first scanning window.

2. The method of claim 1, further comprising:
wherein in response to the processing by the communication device an advertising packet if received during the first scanning window, sending by the communication device a scan request or connection request.

3. The method of claim 1, further comprising:
transmitting by the communication device a second advertising packet on the second advertising channel;
listening by the communication device on the second advertising channel for a connection request or scan request during a second listening time slot after waiting for the time interval at the end of the second advertising packet;
processing by the communication device a connection request or scan request if received during the second listening time slot;
scanning by the communication device on the second advertising channel during a second scanning window for advertising packets upon the end of the second listening time slot if no connection request or scan request is received during the second listening time slot;
processing by the communication device an advertising packet if received during the second scanning window; and
incrementing by the communication device the second advertising channel to provide a third advertising channel if no advertising packet is received during the second scanning window.

4. The method of claim 1, wherein the communication device is backward compatible with the Bluetooth Low Energy specification.

5. A communication device comprising:
an antenna;
a processor coupled to the antenna to implement a communication protocol, the communication protocol comprising;
transmitting by the communication device via the antenna a first advertising packet on a first advertising channel;
listening by the communication device via the antenna on the first advertising channel for a connection request or scan request during a first listening time slot after waiting for a time interval at the end of the first advertising packet;
processing by the communication device a connection request or scan request if received during the first listening time slot;
scanning by the communication device via the antenna on the first advertising channel during a first scanning window for advertising packets upon the end of the first listening time slot if no connection request or scan request is received during the first listening time slot;
processing by the communication device an advertising packet if received during the first scanning window; and
incrementing by the communication device the first advertising channel to provide a second advertising channel if no advertising packet is received during the first scanning window.

6. The communication device of claim 5, the communication protocol further comprising:
wherein in response to the processing by the communication device an advertising packet if received during the first scanning window, sending by the communication device via the antenna a scan request or connection request.

7. The communication device of claim 5, the communication protocol further comprising:
transmitting by the communication device via the antenna a second advertising packet on the second advertising channel;
listening by the communication device via the antenna on the second advertising channel for a connection request or scan request during a second listening time slot after waiting for the time interval at the end of the second advertising packet;
processing by the communication device a connection request or scan request if received during the second listening time slot;
scanning by the communication device via the antenna on the second advertising channel during a second scanning window for advertising packets upon the end of the second listening time slot if no connection request or scan request is received during the second listening time slot;
processing by the communication device an advertising packet if received during the second scanning window; and
incrementing by the communication device via the antenna the second advertising channel to provide a third advertising channel if no advertising packet is received during the second scanning window.

8. The communication device of claim 5, wherein the communication protocol is backward compatible with the Bluetooth Low Energy specification.

9. A non-transitory computer readable medium having instructions stored thereon that when executed by a communication device causes the communication device to perform a method comprising:
transmitting by the communication device a first advertising packet on a first advertising channel;
listening by the communication device on the first advertising channel for a connection request or scan request during a first listening time slot after waiting for a time interval at the end of the first advertising packet;
processing by the communication device a connection request or scan request if received during the first listening time slot;
scanning by the communication device on the first advertising channel during a first scanning window for advertising packets upon the end of the first listening time slot if no connection request or scan request is received during the first listening time slot;
processing by the communication device an advertising packet if received during the first scanning window; and
incrementing by the communication device the first advertising channel to provide a second advertising channel if no advertising packet is received during the first scanning window.

10. The non-transitory computer readable medium of claim 9, the method further comprising:
wherein in response to the processing by the communication device an advertising packet if received during the first scanning window, sending by the communication device a scan request or connection request.

11. The non-transitory computer readable medium of claim 9, the method further comprising:
transmitting by the communication device a second advertising packet on the second advertising channel;
listening by the communication device on the second advertising channel for a connection request or scan request during a second listening time slot after waiting for the time interval at the end of the second advertising packet;
processing by the communication device a connection request or scan request if received during the second listening time slot;
scanning by the communication device on the second advertising channel during a second scanning window for advertising packets upon the end of the second listening time slot if no connection request or scan request is received during the second listening time slot;
processing by the communication device an advertising packet if received during the second scanning window; and
incrementing by the communication device the second advertising channel to provide a third advertising channel if no advertising packet is received during the second scanning window.

12. The non-transitory computer readable medium of claim 9, wherein the method is backward compatible with the Bluetooth Low Energy specification.

13. A method for a communication device to advertise and scan, the method comprising:
means for transmitting by the communication device a first advertising packet on a first advertising channel;
means for listening by the communication device on the first advertising channel for a connection request or scan request during a first listening time slot after waiting for a time interval at the end of the first advertising packet;
means for processing by the communication device a connection request or scan request if received during the first listening time slot;
means for scanning by the communication device on the first advertising channel during a first scanning window for advertising packets upon the end of the first listening time slot if no connection request or scan request is received during the first listening time slot;
means for processing by the communication device an advertising packet if received during the first scanning window; and
means for incrementing by the communication device the first advertising channel to provide a second advertising channel if no advertising packet is received during the first scanning window.

14. The method of claim 13, further comprising:
wherein in response to the means for processing by the communication device an advertising packet if received during the first scanning window, means for sending by the communication device a scan request or connection request.

15. The method of claim 13, further comprising:
means for transmitting by the communication device a second advertising packet on the second advertising channel;
means for listening by the communication device on the second advertising channel for a connection request or scan request during a second listening time slot after waiting for the time interval at the end of the second advertising packet;
processing by the communication device a connection request or scan request if received during the second listening time slot;
means for scanning by the communication device on the second advertising channel during a second scanning window for advertising packets upon the end of the second listening time slot if no connection request or scan request is received during the second listening time slot;
means for processing by the communication device an advertising packet if received during the second scanning window; and
means for incrementing by the communication device the second advertising channel to provide a third advertising channel if no advertising packet is received during the second scanning window.

16. The method of claim 13, wherein the communication device is backward compatible with the Bluetooth Low Energy specification.
